(19) United States
(12) Patent Application Publication
(10) Pub. No.: US 2008/0002104 A1
(43) Pub. Date: Jan. 3, 2008

(54) OPTICAL DEVICE, IMAGE SCANNING APPARATUS, AND IMAGE FORMING APPARATUS

(76) Inventor: Atsuo TOKUNAGA, Kanagawa (JP)

Correspondence Address: HARNESS, DICKEY & PIERCE, P.L.C., P.O. BOX 8910, RESTON, VA, 20195, US

(21) Appl. No.: 11/770,888

(22) Filed: Jun. 29, 2007

(30) Foreign Application Priority Data
Jun. 29, 2006 (JP) 2006-180055

(51) Int. Cl. G02F 1/1333

(52) U.S. Cl. 349/86

(57) ABSTRACT

A disclosed optical device is physically movable with respect to a document surface or an image forming surface. The disclosed optical device includes substrates; optical element groups mounted on the substrates and composed of optical elements for image scanning or image forming, adjacent ones of the optical element groups being spaced at a predetermined distance in a direction that the optical device is movable; and a joining part joining the substrates and thereby maintaining the predetermined distance, the joining part having a thermal coefficient of expansion that is smaller than that of the substrates.

### BACKGROUND OF THE INVENTION

1. Field of the Invention

The present invention generally relates to optical devices, image scanning apparatuses, and image forming apparatuses. More particularly, the present invention relates to an optical device for illuminating an object with light-emitting elements such as LEDs, an optical device for projecting an image from an illuminated object on different positions on an image forming surface, an image scanning apparatus including such optical devices, and an image forming apparatus, for example, a digital multifunction copier having functions of a copier, printer, scanner, and facsimile machine, that includes such optical devices.

2. Description of the Related Art

For a device or an apparatus including an optical system composed of multiple light-receiving elements and/or light-emitting elements spaced at a certain distance, precise spacing of elements is an important factor determining its performance. Examples of such a device and an apparatus include an optical device for illuminating an object with light-emitting elements such as LEDs, an optical device for projecting an image from an illuminated object on different positions on an image forming surface, an image scanning apparatus including such optical devices, and an image forming apparatus, such as a copier or a facsimile machine, that includes such optical devices. Spacing in this case means, for example, spacing between elements disposed on a semiconductor, spacing between semiconductors having elements thereon, and spacing between substrates having such semiconductors thereon. In a charge-coupled device (CCD) used for a reducing image scanning optical system, all pixels are spaced with high precision on a semiconductor. However, it is normally difficult to implement an 1× optical system with one semiconductor (hereafter, “1×” indicates 1:1 magnification). For example, to scan an A3-size (297 mm×420 mm) document lengthwise at a resolution of 600 dpi, light-receiving elements of an 1× image scanning optical system must be arranged at 42 μm intervals (decimal part is truncated) for a width of 297 mm or larger. It is unrealistic to implement such an image scanning optical system with one semiconductor. Therefore, an 1× image scanning optical system that can scan a wide document is normally produced by disposing multiple semiconductors on a substrate. Meanwhile, a lens used in such an 1× image scanning optical system must also be long enough to cover the document width. For example, to cover the width of an A3-size document, the lens must be 294 mm or longer; and to cover the width of an A0-size (841 mm×1189 mm) document, the lens must be 841 mm or longer. One problem is that such a long lens is expensive.

Patent document 1 discloses an optical apparatus composed of multiple optical devices using short 1× lenses. Patent document 2 discloses a technology that makes it possible to precisely space and combine multiple optical devices having short 1× lenses and thereby to provide an 1× optical system having a quality equivalent to that of an 1× optical system using a long lens.

One disadvantage of the disclosed technologies is that those technologies require an adjustment mechanism for adjusting spacing between elements or optical devices and an adjustment tool and process for adjusting the adjustment mechanism. According to the technology disclosed in patent document 2, adjacent substrates (multiple light emitting elements are disposed on each substrate) are joined at one point so as to improve the positional accuracy of the substrates in the main-scanning direction (a direction along which light-emitting elements are arranged) and to space the substrates with high accuracy in the sub-scanning direction (a direction orthogonal to the main-scanning direction). With this configuration, the number of joints between substrates becomes one smaller than the number of substrates n. Therefore, the adjustment process must be performed for n-1 number of times. Patent document 3 discloses a technology that makes it possible to eliminate the need to perform such adjustment processes.

[Patent document 1] Japanese Patent Application Publication No. 7-61035

[Patent document 2] Japanese Patent Application Publication No. 2001-328292

[Patent document 3] Japanese Patent Application Publication No. 11-277795

FIG. 26 is a drawing illustrating a schematic configuration of an exemplary conventional optical device where multiple light-receiving elements (or light-emitting elements) are disposed on a substrate. As shown in FIG. 26, the exemplary optical device includes a substrate 500 and first and second components 501 and 502 disposed on the substrate 500 in the x direction. The first and second components 501 and 502 have n-pixels of light-receiving elements (or light-emitting elements) 503 and 504, respectively. The light-receiving elements 503 and 504, respectively, are disposed at pitch Pg. A distance P between pixels positioned at adjacent ends of the first and second components 501 and 502 is obtained by the formula P=(Px²+Py²)^{1/2}. When the pitch Pg between the pixels is 42 μm (corresponds to one 600-dpi pixel in an 1× optical system), it is ideal to set the distance Px also at 42 μm. The length in the x direction of each of the first and second components 501 and 502 roughly corresponds to Pg×n.

When glass epoxy having a thermal coefficient of expansion of about 20 [10⁻⁶/° C.] is used as the material of the substrate 500 and the temperature changes 50° C., it is necessary to set the distance P at 10 mm or smaller to contain the influence of the expansion of the substrate 500 within a tolerance of 10 μm (corresponds to ¼ 600-dpi pixel in an 1× optical system). Based on the above conditions, the distance P of 10 mm is obtained as follows:

10[μm]/(20[10⁻⁶/° C.]×50[° C.])=10[mm]

Although it is rather easy to set the distance Px to meet this requirement, it is difficult to set the distance Py at this level. This causes a problem especially when arranging the first and second components 501 and 502 in a line in the x direction or when arranging 1× lenses in positions corresponding to the first and second components 501 and 502.

Since the distance Py between the light-receiving elements (or light-emitting elements) 503 and 504 is rather large, it is influenced by the expansion of the substrate 500 caused by temperature change. This, in turn, makes it necessary to take measures to reduce the influence. On the other hand, the distance Px is rather small and is therefore not influenced much by such expansion of the substrate 500. This is true even when more than two components are arranged on a substrate.

FIG. 27 is a drawing illustrating a schematic configuration of another exemplary conventional optical device where multiple light-receiving elements (or light-emitting elements) are disposed on substrates. As shown in FIG. 27, the exemplary optical device includes an element group 511(a) disposed on a substrate 510, an element group 521(b) disposed on a substrate 520, and an element group 531 disposed on two substrates 530 composed of the same material and joined by a substrate 540(c). When the thermal coefficients of expansion of the substrates 510, 520, 530, and 540 are different, the expansion of the substrates may cause misalignment between the element groups 511, 521, and 531.

For example, when the distance Rx between elements 521a and 521b of the element group 521 and the distance Rx between elements 531a and 531b of the element group 531 are both 200 mm, the substrates 520 and 530 are composed of glass epoxy, and the substrate 540 is a steel plate, it is necessary to set the distance between pixels at 25 mm or smaller in an environment where the temperature changes 50° C. (10[μm]/{(20[10⁻⁶/° C.]×50[° C.])−(12[10⁻⁶/° C.]×50[° C.])}=25[mm]).

FIG. 28 is a drawing illustrating an exemplary conventional 1× optical device used in image scanning apparatuses. As shown in FIG. 28, the exemplary 1× optical device includes an 1× sensor 1 and an 1× lens (1× imaging element) 2. The 1× sensor 1 and the 1× lens 2 are disposed on the lower surface of a contact glass plate 3, i.e. on the same side as white light sources 4. The white light sources 4 illuminate a document 5 placed on the upper surface of the contact glass plate 3. Reflected light from the document 5 is guided by the 1× lens 2 to the 1× sensor 1. Thus, the exemplary 1× optical device is configured to scan a document. As the 1× lens 2, a SELFOC lens is normally used. In an 1× optical system, the size of a pixel is larger than that in a reducing optical system and therefore, in addition to a CCD sensor, a MOS sensor may be used as the 1× sensor 1. Also, in an 1× optical system, since the large pixel size makes it easier to increase the sensitivity of a sensor and the optical path length of an 1× lens is short, the light intensity of a light source can be lower than that in a reducing optical system. Therefore, in addition to xenon lamps and fluorescent lamps, LEDs and organic EL devices may also be used as the white light sources 4.

FIG. 29A is a drawing illustrating a LED printer head of an exemplary 1× optical device used in image forming apparatuses and FIG. 29B is a drawing illustrating a SELFOC lens of the exemplary 1× optical device. The exemplary 1× optical device is an optical writing device and includes a LED printer head (LPH) 10 shown in FIG. 29A and a SELFOC lens 12 shown in FIG. 29B. As shown in FIG. 29A, the LPH 10 includes multiple integrated LED chips disposed on the back side of a substrate 11. Light emitted from the LED chips is focused by the SELFOC lens 12 to form an image. The LPH 10 also includes driver elements 15 for driving the LED chips on the upper side of the substrate 11. The driver elements 15 are connected by a connector 13 to a control circuit (not shown). Further, the LPH 10 includes a radiator plate 14. LED printer heads as exemplified by the LPH 10 are small and have simple configurations, and are therefore used in many facsimile machines and printers. However, low light intensity of LEDs and difficulty in increasing the integration density of LEDs are making it difficult to produce an optical writing device for high-resolution imaging with such LED printer heads.

Meanwhile, in an optical writing device using LEDs, it is necessary to provide a mechanism to reduce the difference in light intensity between the LEDs. There are roughly two methods for causing LEDs to emit light: a strobe method and a dynamic method. In the strobe method, after luminescence data for each of LEDs are transferred, the LEDs are simultaneously lit by a strobe signal. In this method, strobing is normally performed in batches to allow low data transfer speed and to reduce fluctuation in the input current that occurs when the LEDs are lit. In the dynamic method, individual LEDs are lit dynamically. Although a complicated control circuit is required, this method does not cause much fluctuation in the input current.

FIG. 29C is a drawing illustrating an image forming unit of a conventional electrophotographic image forming apparatus. In the conventional image forming apparatus, the surface of a photosensitive drum 131 is charged by a charging unit 132. A latent image is formed by illuminating the charged surface with a laser beam emitted from a LED 133 and focused by a lens 134. The latent image is developed with toner by a developing unit 135. The developed image is transferred onto paper by a transfer unit 136 and the paper is separated by a separating unit 137 from the photosensitive drum 131. The transferred image is fused onto the paper with pressure and heat by a fusing unit 138. Then, the paper is ejected. Meanwhile, toner remaining on the surface of the photosensitive drum 131 is removed by a cleaning unit 139. Also, any residual charge on the surface of the photosensitive drum 131 is removed by a discharging unit 140 so that the photosensitive drum 131 can be charged for the next image forming.

In conventional devices or apparatuses as described above, positions of LEDs disposed on a substrate(s) may be shifted because of expansion of the substrate(s) caused by temperature change. Therefore, for use in an environment where temperature varies greatly, it is necessary to provide a mechanism to detect the temperature change or the positional shift and to feed back the detected results.

### SUMMARY OF THE INVENTION

The present invention provides optical devices, image scanning apparatuses, and image forming apparatuses that substantially obviate one or more problems caused by the limitations and disadvantages of the related art.

An embodiment of the present invention provides an optical device including multiple light-receiving element groups and/or light-emitting element groups where positional shifts of the element groups caused by temperature change are reduced.

An embodiment of the present invention provides an optical device that is physically movable with respect to a document surface or an image forming surface. The optical device includes substrates; optical element groups mounted on the substrates and composed of optical elements for image scanning or image forming, adjacent ones of the optical element groups being spaced at a predetermined distance in a direction that the optical device is movable; and a joining part joining the substrates and thereby maintaining the predetermined distance, the joining part having a thermal coefficient of expansion that is smaller than that of the substrates.

Another embodiment of the present invention provides an optical device including substrates; optical element groups mounted on the substrates and composed of optical elements for image scanning or image forming, the optical element groups being disposed in a line, adjacent ones of the optical element groups being spaced at a predetermined distance; and a joining part joining the substrates and thereby maintaining the predetermined distance, the joining part having a thermal coefficient of expansion that is equal or close to that of the substrates.

### BRIEF DESCRIPTION OF THE DRAWINGS

FIG. 1 is a drawing illustrating a configuration of a wide-format digital copier as an exemplary image forming apparatus according to an embodiment of the present invention;

FIG. 2 is a block diagram illustrating configurations of a control unit and a document feeding/scanning unit of the exemplary image forming apparatus;

FIG. 3 is a plan view of an optical device according to a first embodiment;

FIG. 4 is a drawing used to describe an optical device according to a second embodiment;

FIG. 5 is a plan view of a LED writing unit, according to a third embodiment, of an image forming apparatus;

FIG. 6 is a plan view of a LED writing unit, according to a fourth embodiment, of an image forming apparatus;

FIG. 7 is a drawing used to describe the relationship between the distance between joint positions and the distance between element groups according to a fifth embodiment;

FIG. 8 is a drawing illustrating a cooling unit according to a sixth embodiment, provided on a joining part, for reducing expansion of the joining part caused by temperature change;

FIG. 9 is a drawing illustrating an optical device according to a seventh embodiment configured to reduce the influence of expansion of substrates caused by temperature change;

FIG. 10 is a drawing illustrating a substrate having a slit according to an eighth embodiment;

FIGS. 11A and 11B are drawings illustrating exemplary configurations of optical devices according to a ninth embodiment;

FIG. 12 is a drawing illustrating an exemplary optical device configured to form a latent image on the surface of a photosensitive drum;

FIG. 13 is a drawing illustrating a variation of the exemplary optical device shown in FIG. 12 having a mechanism to adjust the positions of light-emitting elements along the optical axes of lenses;

FIG. 14 is a drawing illustrating a variation of the exemplary optical device shown in FIG. 13 having a mechanism to adjust the positions of light-emitting elements along the optical axes of lenses while maintaining the right angles between the light-emitting surfaces of light-emitting elements and the optical axes of lenses;

FIG. 15 is a drawing illustrating an exemplary mounting position of a temperature sensor according to an eleventh embodiment;

FIG. 16 is a drawing illustrating another exemplary mounting position of a temperature sensor according to the eleventh embodiment;

FIG. 17 is a drawing illustrating another exemplary mounting position of a temperature sensor according to the eleventh embodiment;

FIG. 18 is a drawing illustrating still another exemplary mounting position of a temperature sensor according to the eleventh embodiment;

FIG. 19 is an exploded perspective view of an example of a temperature sensor and mounting parts;

FIG. 20 is an exploded perspective view of another example of a temperature sensor and mounting parts;

FIG. 21 is a drawing illustrating a configuration of an exemplary temperature detecting circuit according to the eleventh embodiment;

FIG. 22A is a graph showing the relationship between temperatures detected by a temperature sensor of the eleventh embodiment and resistance values;

FIG. 22B is a graph showing the relationship between temperatures obtained by a temperature detecting circuit and voltages;

FIG. 23 is flowchart showing an exemplary temperature detecting process according to the eleventh embodiment;

FIG. 24 is a flowchart showing an exemplary process, according to the eleventh embodiment, of scanning an image using light-receiving element groups arranged in a staggered manner;

FIG. 25 is a flowchart showing an exemplary process, according to the eleventh embodiment, of forming an image using light-emitting element groups arranged in a staggered manner;

FIG. 26 is a drawing illustrating a schematic configuration of an exemplary conventional optical device where multiple light-receiving elements (or light-emitting elements) are disposed on a substrate;

FIG. 27 is a drawing illustrating a schematic configuration of another exemplary conventional optical device where multiple light-receiving elements (or light-emitting elements) are disposed on substrates;

FIG. 28 is a drawing illustrating an exemplary conventional 1× optical device used in image scanning apparatuses;

FIG. 29A is a drawing illustrating a LED printer head of an exemplary 1× optical device used in image forming apparatuses;

FIG. 29B is a drawing illustrating a SELFOC lens of the exemplary 1× optical device; and

FIG. 29C is a drawing illustrating an image forming unit of a conventional electrophotographic image forming apparatus.

### DESCRIPTION OF THE PREFERRED EMBODIMENTS

Preferred embodiments of the present invention are described below with reference to the accompanying drawings.

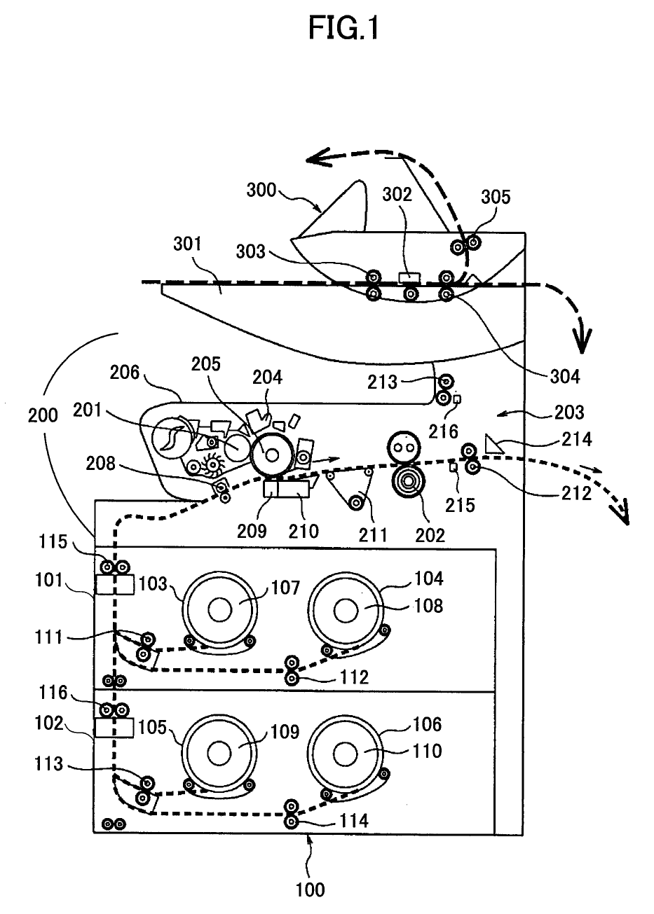

FIG. 1 is a drawing illustrating a configuration of a wide-format digital copier as an exemplary image forming apparatus according to an embodiment of the present invention. As shown in FIG. 1, the exemplary image forming apparatus (wide-format digital copier) includes a paper-feeding unit 100, an image forming unit 200 stacked on the paper-feeding unit 100, and a scanning unit 300 stacked on the image forming unit 200. Operations and configurations of each unit in the exemplary image forming apparatus are described below.

A document placed on a document table 301 of the scanning unit 300 is fed into the scanning unit 300 page by page. Each page of the document is scanned by a contact image sensor (CIS) 302 to obtain image data and is then ejected onto a paper catch tray. More specifically, side edges (edges along the document-conveying direction) of pages of the document placed on the document table 301 are aligned by side walls (not shown). Then, the document is fed page by page by paper-feeding rollers 303 into a position under the contact image sensor 302. A document width detecting sensor and a document length detecting sensor (not shown) are provided on the document table 301 to detect the size of a document. Each page of the document fed into a position under the contact image sensor 302 is illuminated by a light source such as a LED array or a fluorescent lamp. Light reflected from each page passes through a rod lens array and forms an image on the contact image sensor 302. The contact image sensor 302 photoelectrically converts the optical image. After being scanned, each page of the document is ejected onto a paper catch tray by conveying rollers 304 and paper-ejecting rollers 305.

The image forming unit 200 includes a developing unit 201, a fusing unit 202, and a paper-ejecting unit 203. An image signal obtained by photoelectric conversion by the contact image sensor 302 is processed by an image processing unit. According to the processed image signal, a LED writing unit 204 forms an electrostatic latent image on a photosensitive drum 205 uniformly charged by a charger. The latent image is developed with toner by the developing unit 201 positioned downstream of the LED writing unit 204 in the rotation direction of the photosensitive drum 205. The toner image is transferred by a transfer unit 209 onto recording paper fed from the paper-feeding unit 100. The recording paper is separated by a separating unit 210 from the photosensitive drum 205 and conveyed by a conveyor belt 211 to the fusing unit 202. The toner image is fused onto the recording paper by the fusing unit 202. Then, the recording paper with the image is ejected via the paper-ejecting unit 203 to a paper catch tray 206 above the image forming unit 200 or a paper catch tray (not shown) at the rear of the image forming unit 200.

The paper-feeding unit 100 includes two stacked roll paper trays 101 and 102. The roll paper trays 101 and 102 can be pulled out from the body of the exemplary image forming apparatus to the left in FIG. 1 to set paper rolls or to remove jammed paper. Each of the roll paper trays 101 and 102 can hold two paper rolls. Paper rolls 103 through 106, which are wound around paper cores, are held by paper holders 107 through 110 in the roll paper trays 101 and 102, respectively. Paper-feeding rollers 111 through 114 are provided near the respective paper holders 107 through 110. Paper fed by any one of the paper-feeding rollers 111 through 114 is cut at a specified length by a roll cutter unit 115 or 116 positioned near the front (left side in FIG. 1) of the corresponding roll paper tray 101 or 102. The cut paper is fed into the image forming unit 200. The cut paper is further fed by resist rollers 208 into a position between the photosensitive drum 205 and the transfer unit 209 in synchronization with an image forming process. A toner image formed on the photosensitive drum 205 is transferred onto the cut paper by the transfer unit 209. The cut paper is then separated by the separating unit 210 from the photosensitive drum 205 and conveyed by the conveyor belt 211 to the fusing unit 202. The transferred image is fused onto the cut paper with heat by the fusing unit 202. The cut paper with the fused image is ejected by paper-ejecting rollers 212 and/or 213 constituting the paper-ejecting unit 203. The destination of the ejected cut paper is switched by a branch claw 214 either to the paper catch tray 206 above the image forming unit 200 or to a paper catch tray (not shown) at the rear of the image forming unit 200.

A paper ejection sensor 215 is provided between the fusing unit 202 and the paper-ejecting rollers 212, and a paper ejection sensor 216 is provided between the paper-ejecting rollers 212 and the paper-ejecting rollers 213. The paper ejection sensors 215 and 216 are used to detect paper in the paper-ejecting unit 203.

Although not shown in FIG. 1, the image forming unit 200 may further include a control unit for driving the paper-ejecting rollers 212 and 213, and the scanning unit 300 may further include an operations unit for entering user instructions and specifying options such as the number of copies and the length at which roll paper is cut.

The fusing unit 202 includes a fusing roller composed of a metal tube and a release layer; a pressure roller composed of a metal tube, a rubber layer, and a release layer; a primary heating unit that heats up when AC power is supplied from an AC power supply; a secondary heating unit that heats up when power is supplied from a secondary power supply; an electromagnetic motor for rotating the fusing roller; a voltage sensor for detecting the charging voltage of the secondary power supply; a temperature detecting unit for detecting the surface temperature of the fusing roller and the pressure roller; a transmission gear for transmitting the rotational movement of the electromagnetic motor; and a fusing roller driving gear for transmitting the rotational movement from the transmission gear to the fusing roller.

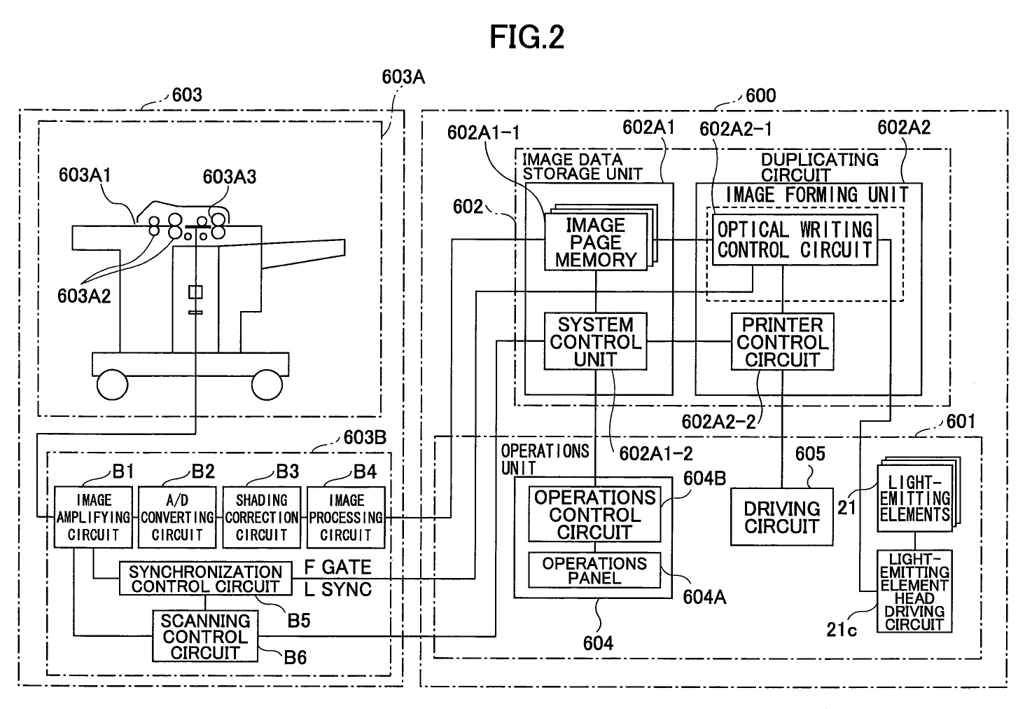

FIG. 2 is a block diagram illustrating configurations of a control unit and a document-feeding/scanning unit of the exemplary image forming apparatus.

The exemplary image forming apparatus includes a control unit 600 and a document feeding/scanning unit 603. The control unit 600 includes a printer engine 601 and a control circuit 602 for controlling the printer engine 601.

As described above, the exemplary image forming apparatus has a function to scan and duplicate a wide format document. The document feeding/scanning unit 603 includes a mechanical unit 603A and an image processing unit 603B. The mechanical unit 603A scans a document and thereby obtains image data. The image processing unit 603B digitizes the obtained image data, performs image processing on the digitized image data, and outputs the processed image data to the control unit 600. A document inserted into a document insertion opening 603A1 of the mechanical unit 603A is conveyed by conveying rollers 603A2 through a conveying path 603A3 to a paper catch tray. While being conveyed through the conveying path 603A3, the document is scanned by the contact image sensor 302 shown in FIG. 1 at a scanning position.

The image processing unit 603B includes an image amplifying circuit B1, an A/D converting circuit B2, a shading correction circuit B3, an image processing circuit B4, a synchronization control circuit B5, and a scanning control circuit B6. An optical image of the document is converted into an electric image signal by the contact image sensor 302. The image amplifying circuit B1 amplifies the image signal and outputs the amplified image signal to the A/D converting circuit B2, the synchronization control circuit B5, and the scanning control circuit B6. The A/D converting circuit B2 converts the image signal from analog to digital and outputs the converted image signal to the shading correction circuit B3. The shading correction circuit B3 performs shading correction on the converted image signal and outputs the corrected image signal to the image processing circuit B4. The image processing circuit B4 performs image processing such as gamma correction on the corrected image signal and sends the processed image signal to an image page memory 602A1-1 where the processed image signal is stored.

The synchronization control circuit B5 generates an FGATE signal and an LSYNC signal based on the image signal from the image amplifying circuit B1 and outputs the signals to an optical writing control circuit 602A2-1. The scanning control circuit B6 generates a scanning control signal based on the FGATE and LSYNC signals from the synchronization control unit B5 and outputs the scanning control signal to a system control unit 602A1-2.

The control circuit 602 includes an image data storage unit 602A1 and a duplicating circuit 602A2. The image data storage unit 602A1 includes the image page memory 602A1-1 and the system control unit 602A1-2. The duplicating circuit 602A2 includes the optical writing control circuit 602A2-1 that is a part of an image forming unit and a printer control circuit 602A2-2. The printer engine 601 includes a driving circuit 605, light-emitting elements 21, a light-emitting element head driving circuit 21c, and an operations unit 604 that includes an operations control circuit 604B and an operations panel 604A.

When an instruction is entered via the operations panel 604A to the operations control circuit 604B, the optical writing control circuit 602A2-1 retrieves image data from the image page memory 602A1-1 and outputs control signals to the light-emitting element head control circuit 21c and the printer control circuit 602A2-2. Then, the printer control circuit 602A2-2 outputs a control signal to the driving unit 605. In the printer engine 601, the light-emitting element head control circuit 21c drives the light-emitting elements 21 based on the control signal from the optical writing control circuit 602A2-1 to form a latent image on the photosensitive drum 205 of the image forming unit 200. The driving unit 605 drives the image forming unit 200 of FIG. 1 to form a visible image on paper based on the control signal from the printer control circuit 602A2-2.

### First Embodiment

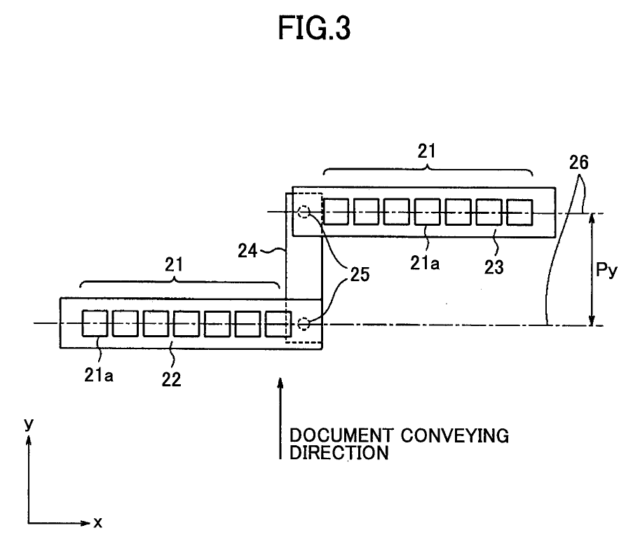

FIG. 3 is a plan view of an exemplary optical device according to a first embodiment used for image scanning in the exemplary image forming apparatus described above with reference to FIGS. 1 and 2. The exemplary optical device of the first embodiment includes light-receiving element groups 21 each composed of multiple light-receiving elements 21a for converting an optical image reflected from a document into an electric signal. The exemplary optical device of the first embodiment is physically movable with respect to the surface of a document (in the y direction of FIG. 3). The light-receiving element groups 21 are disposed on different substrates and spaced at a predetermined distance in the physically movable direction (the y direction). The substrates are joined and kept apart by a joining part with a thermal coefficient of expansion smaller than that of the substrates to maintain the predetermined distance.

More specifically, the light-receiving elements 21a of the light-receiving element groups 21 are disposed in a line on a first substrate 22 and a second substrate 23, respectively. The first and second substrates 22 and 23 are disposed parallel to each other in a staggered manner at a distance Py and joined by a joining part 24 that is orthogonal to the substrates and has a thermal coefficient of expansion that is smaller than that of the substrates 22 and 23. The ends of the joining part 24 are joined to the corresponding ends of the first and second substrates 22 and 23 such that the first and second substrates 22 and 23 are placed in base positions 26 and extend in the main-scanning direction. The reference number 25 indicates joint positions where the joining part 24 is attached to the first and second substrates 22 and 23.

### Second Embodiment

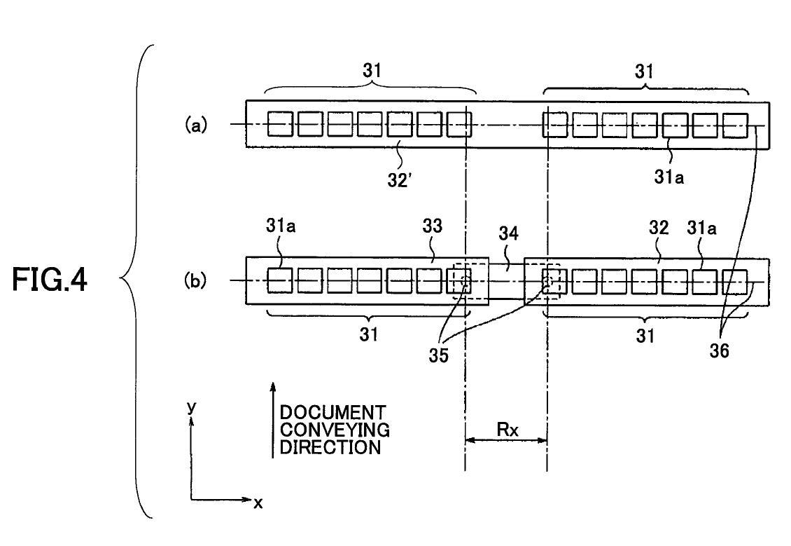

FIG. 4 is a drawing used to describe an exemplary optical device according to a second embodiment. FIG. 4(a) shows a conventional optical device where light-receiving element groups 31 are disposed on one substrate 32′. FIG. 4(b) shows the exemplary optical device of the second embodiment where the light-receiving element groups 31 are disposed on substrates 32 and 33, respectively, and the substrates 32 and 33 are joined by a joining part 34.

Each of the light-receiving element groups 31 is composed of multiple light-receiving elements 31a for converting optical image reflected from a document into an electric signal. The light-receiving element groups 31 are spaced at a predetermined distance by the joining part 34 joining the substrates 32 and 33. The joining part 34 has a thermal coefficient of expansion that is equal or close to that of the substrates 32 and 33.

In other words, the light-receiving element groups 31 are disposed in a line in the x direction and spaced at a distance Rx by the joining part 34.

In the second embodiment, descriptions of parts corresponding to those described in the first embodiment are omitted.

### Third Embodiment

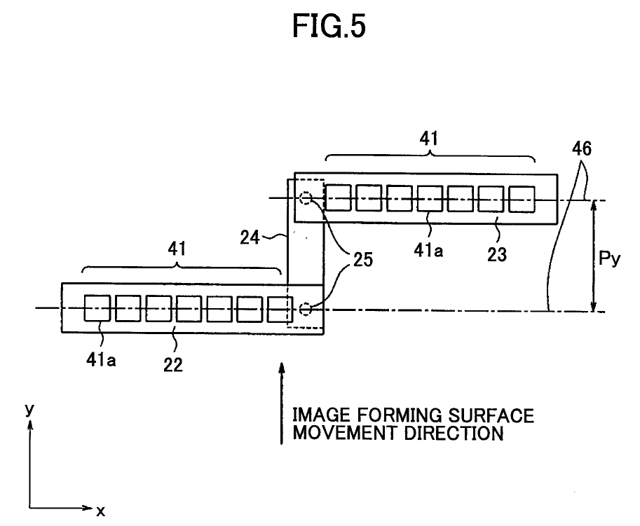

FIG. 5 is a drawing illustrating an exemplary configuration of the LED writing unit 204 according to a third embodiment of the exemplary image forming apparatus described above with reference to FIGS. 1 and 2. The third embodiment is different from the first embodiment shown in FIG. 3 in that the light-receiving element groups 21 are replaced with light-emitting element groups 41 each composed of light-emitting elements 41a. In the descriptions below, the same reference numbers are used for parts corresponding to those of the first embodiment, and descriptions of those parts are omitted.

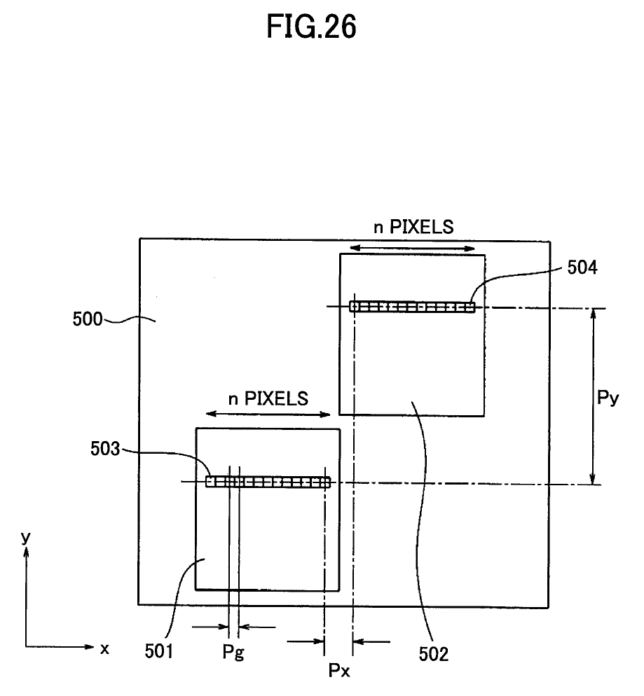

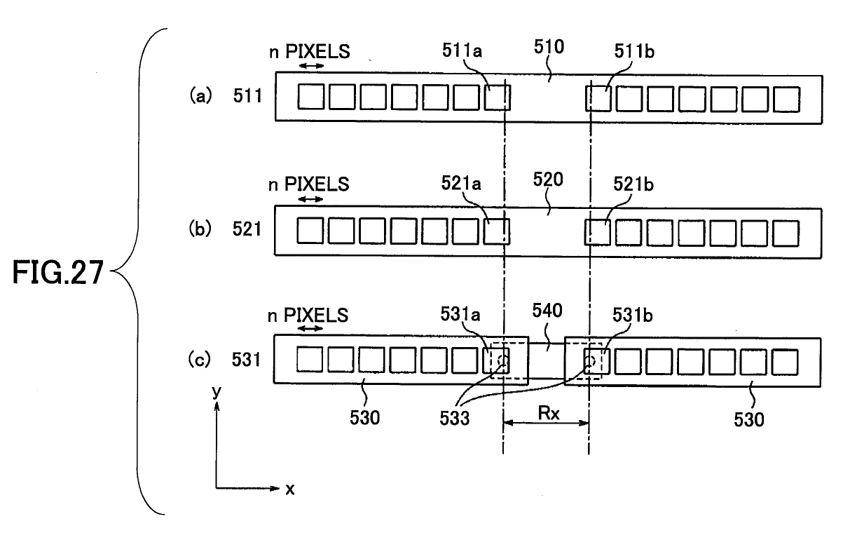

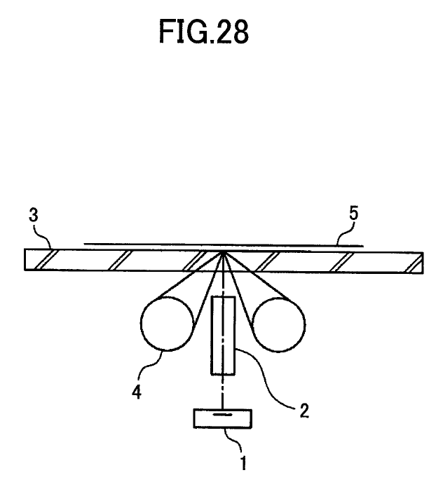

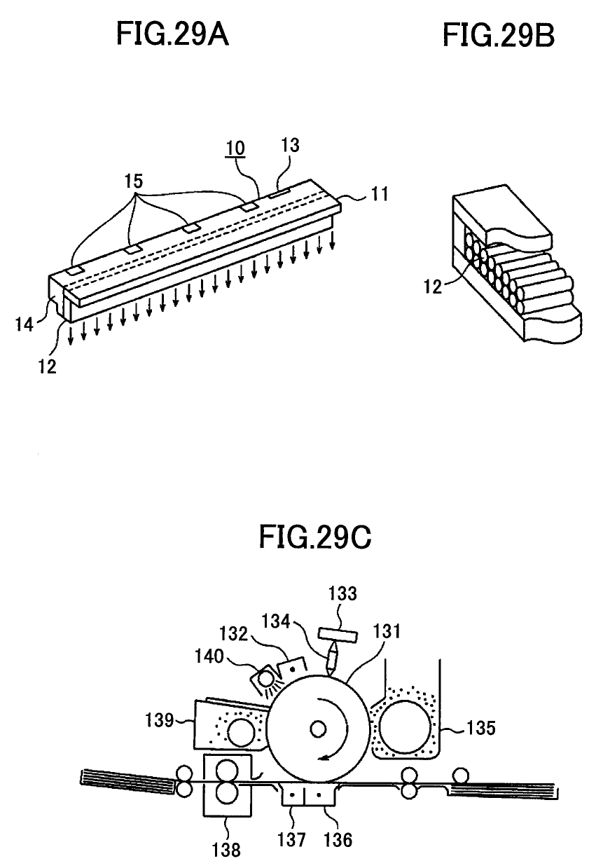

Since the joining part 24 is composed of a material having a small thermal coefficient of expansion, the first and third embodiments make it possible to increase the allowable limit of the distance Py while containing the influence of temperature change within a predetermined tolerance described above with reference to FIG. 26. For example, when a steel plate with a thermal coefficient of expansion of about 12[10⁻⁶/° C.] is used as the joining part 24 and when other conditions are substantially the same as those described above with reference to FIG. 26, the distance P can be increased up to 16.6 mm.

### Fourth Embodiment

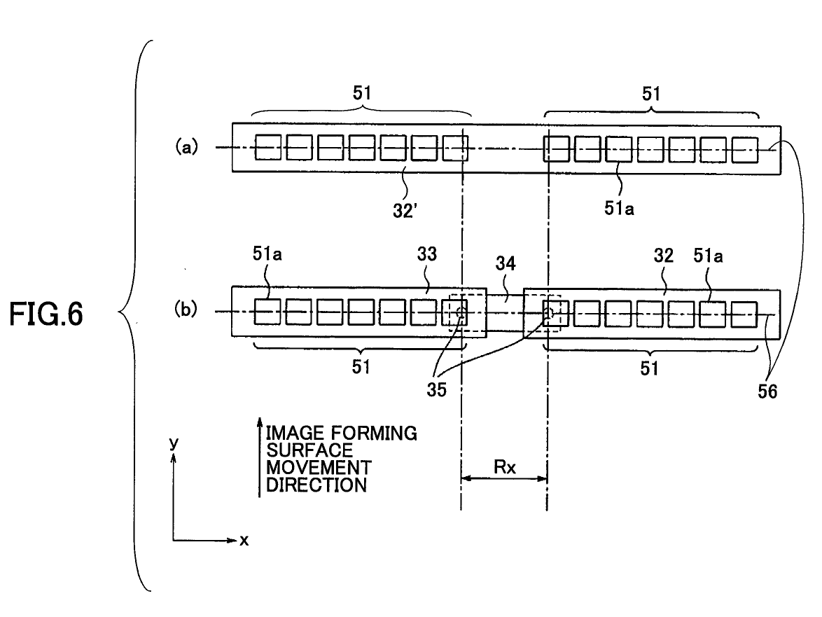

FIG. 6 is a drawing illustrating another exemplary configuration of the LED writing unit 204 according to a fourth embodiment of the exemplary image forming apparatus. FIG. 6(a) shows a conventional LED writing unit where light-emitting element groups 51 are disposed on one substrate 32′. FIG. 6(b) shows the LED writing unit 204 according to the fourth embodiment where the light-emitting element groups 51 are disposed on substrates 32 and 33, respectively, and the substrates 32 and 33 are joined by a joining part 34.

The fourth embodiment is different from the second embodiment shown in FIG. 4 in that the light-receiving element groups 31 are replaced with the light-emitting element groups 51 each composed of light-emitting elements 51a. In the descriptions below, the same reference numbers are used for parts corresponding to those of the second embodiment, and descriptions of those parts are omitted.

Since the joining part 34 is composed of a material having a thermal coefficient of expansion that is equal or close to that of the substrates 32 and 33 arranged in the x direction, the second and fourth embodiments make it possible to increase the allowable limit of the distance Rx while containing the influence of temperature change within a predetermined tolerance described above with reference to FIG. 27. For example, when an aluminum plate with a thermal coefficient of expansion of about 24[10⁻⁶/° C.] is used as the joining part 24 and when other conditions are substantially the same as those described above with reference to FIG. 27, the distance between the light-emitting element groups 51 can be increased up to 50 mm. Also, if a material with the same thermal coefficient of expansion as that of the substrates 32 and 33 is used, the distance between pixels can be determined freely.

### Fifth Embodiment

An exemplary optical device according to a fifth embodiment is configured such that the ratio of the distance Py to the distance between the joint positions 25 becomes equal to the ratio of the difference between the thermal coefficients of expansion of the substrates 22 and 23 and the joining part 24 to the thermal coefficient of expansion of the substrates 22 and 23.

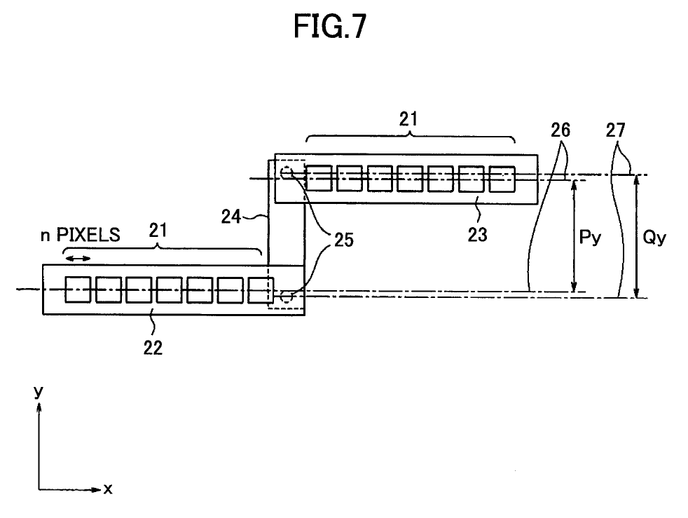

As shown in FIG. 7, the distance in the y direction between the light-receiving element groups 21 is Py and the distance between the joint positions 25 is Qy. When the substrates 22 and 23 are composed of glass epoxy, the joining part 24 is a steel plate, and the temperature change is 50° C.; setting the joint positions 25 at the distance Qy makes the change in distance (distance change), which is caused by the temperature change, between the light-receiving element groups 21 smaller than that when the joint positions 25 are set at the distance Py. Assuming that the distance Py is 15 mm and the distance Qy is 20 mm,

the distance change Δpy0 when the joint positions 25 are set at the distance Py is obtained by the following formula:

Δpy0=Py×12[10⁻⁶/° C.]×50[° C.]=9[μm]

and, the distance change Δpy when the joint positions 25 are set at the distance Qy is obtained by the following formula:

Δpy=Qy×12[10⁻⁶/° C.]×50[° C.]−(Qy−Py)×20[10⁻⁶/° C.]×50[° C.]=7[μm]

Further, it is possible to eliminate the distance change by making the ratio (Py:Qy) of the distance Py (between the light-receiving element groups 21) to the distance Qy equal to the ratio (k-kg:k) of the difference between the thermal coefficient of expansion k of the substrates 22 and 23 and the thermal coefficient of expansion kg of the joining part 24 to the thermal coefficient of expansion k. For example, when the distance Py is 8 mm and the distance Qy is 20 mm,

the distance change Δqy in a portion between the joint positions 25 spaced at the distance Qy is obtained by the following formula:

Δqy=Qy×12[10⁻⁶/° C.]×50[° C.]=12[μm]

and, the distance change Δsy in a portion between the joint position 25 and the base position 26 is obtained by the following formula:

Δsy=(1/2)×(Qy−Py)×20[10⁻⁶/° C.]×50[° C.]=6[μm]

Since the distance change Δsy applies to two portions between the joint positions 25 and the base positions 26, the distance change Δsy is multiplied by two. Accordingly, Δqy=Δsy×2 becomes true and the distance change Δqy is offset by the distance change Δsy×2.

In the fifth embodiment, descriptions of parts corresponding to those described in the first through fourth embodiments are omitted.

### Sixth Embodiment

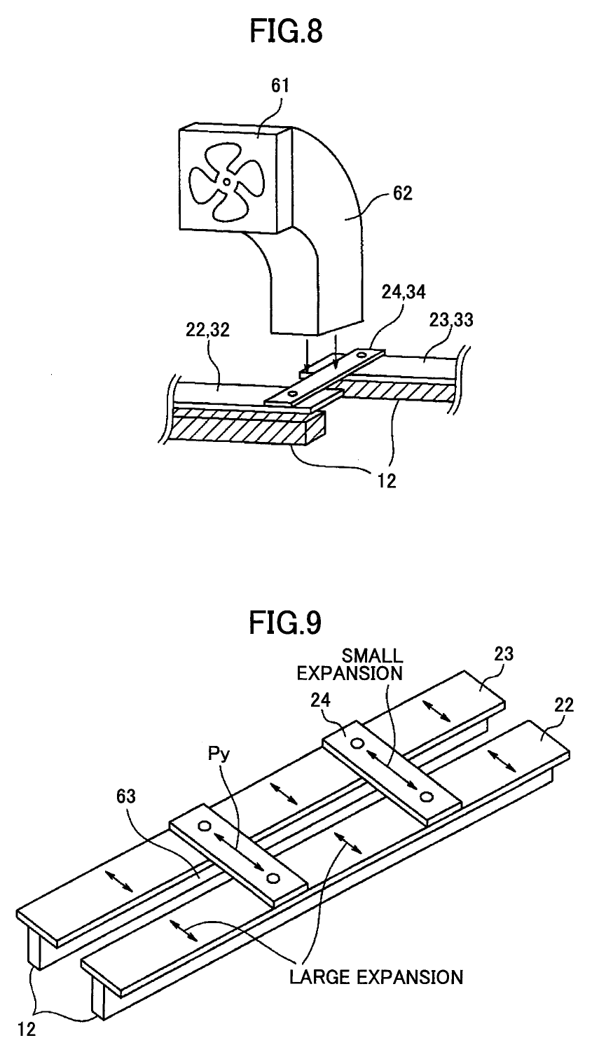

FIG. 8 is a drawing illustrating a cooling unit according to a sixth embodiment which is provided on a joining part and used to reduce expansion of the joining part caused by temperature change. In the sixth embodiment, a cooling unit is provided on the joining part 24 or 34 of each optical device of the first through fifth embodiments to reduce expansion of the joining part 24 or 34 caused by temperature change. The cooling unit includes a fan 61 and a duct 62. The air outlet of the duct 62 faces the joining part 24 or 34. Air drawn in by the fan 61 is guided by the duct 62 and blown onto the joining part 24 or 34 to cool it. In FIG. 8, reference numbers 22, 32, 23, and 33 indicate the substrates of the first through fifth embodiments and reference number 12 indicates 1× lenses.

In the sixth embodiment, descriptions of parts corresponding to those described in the first through fifth embodiments are omitted.

### Seventh Embodiment

FIG. 9 is a drawing illustrating an exemplary optical device according to a seventh embodiment configured to reduce the influence of expansion of substrates caused by temperature change. The exemplary optical device of the seventh embodiment includes substrates 22 and 23 joined by joining parts 24. Also, it is assumed that light-receiving element groups or light-emitting element groups (hereafter, collectively called optical element groups 20) are mounted on the substrates 22 and 23. The optical element group 20 on the substrate 22 and the optical element group 20 on the substrate 23 are spaced at a distance Py.

The thermal coefficient of expansion of the joining parts 24 is small compared with that of the substrates 22 and 23 and a gap 63 is provided between the substrates 22 and 23. With this configuration, even when the amount of expansion of the substrates 22 and 23 in directions orthogonal to the rows of optical elements (the optical element groups 20) is large, since the substrates 22 and 23 can expand in both directions with respect to the joint positions, the change of the distance Py is limited to the amount of expansion of the joining parts 24. Thus, the configuration according to the seventh embodiment makes it possible to minimize the change of the distance Py.

In the seventh embodiment, descriptions of parts corresponding to those described in the first through sixth embodiments are omitted.

### Eighth Embodiment

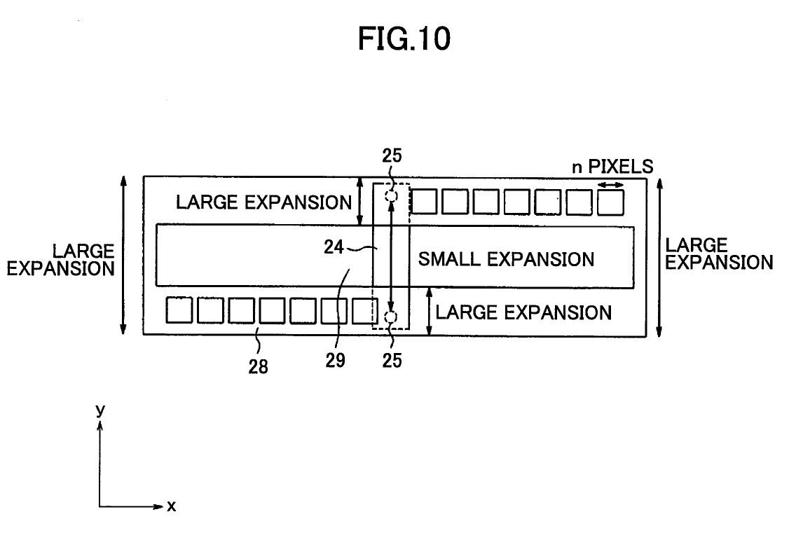

FIG. 10 is a drawing illustrating an exemplary optical device according to an eighth embodiment. The exemplary optical device of the eighth embodiment includes a substrate 28 having a slit 29. Two sides of the substrate 28 separated by the slit 29 are joined by a joining part 24. A light-receiving element group or a light-emitting element group (an optical element group 20) is mounted on each of the two sides of the substrate 28. The optical element group 20 on one side of the substrate 28 and the optical element group 20 on the other side of the substrate 28 are spaced at a predetermined distance. The slit 29 absorbs stress applied to the joining part 24 which stress is caused by expansion of the substrate 28 due to temperature change, and thereby makes it possible to limit the change of the predetermined distance to the amount of expansion of the joining part 24. Joint positions 25 shown in FIG. 10 of the eighth embodiment correspond to those shown in FIG. 7 of the fifth embodiment. Therefore, with the configuration according to the eighth embodiment, the change of the predetermined distance can be offset as described in the fifth embodiment.

In the eighth embodiment, descriptions of parts corresponding to those described in the first through seventh embodiments are omitted.

### Ninth Embodiment

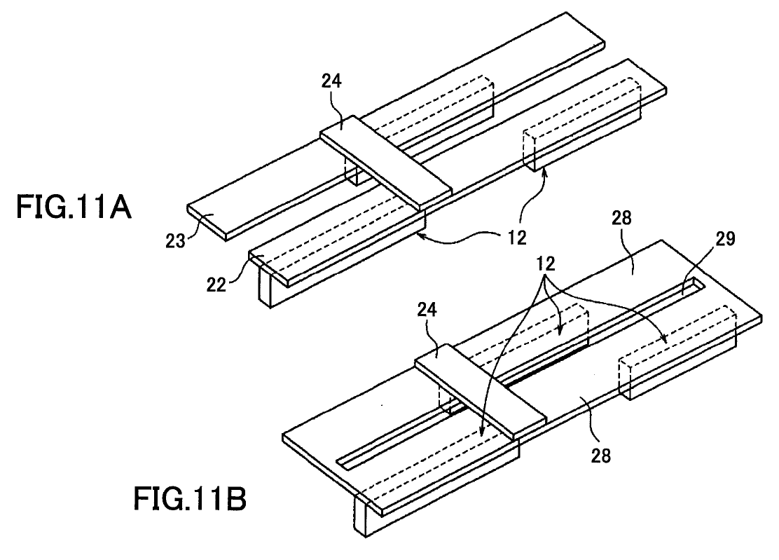

FIGS. 11A and 11B are drawings illustrating exemplary configurations of optical devices according to a ninth embodiment. FIG. 11A shows an exemplary configuration of an optical device according to the ninth embodiment formed by combining configurations of the first embodiment shown in FIG. 3 and the seventh embodiment shown in FIG. 9. The optical device of FIG. 11A includes substrates 22 and 23 joined by a joining part 24. Although not shown, it is assumed that optical element groups 20 are mounted on the substrates 22 and 23 in a staggered manner. The optical device of FIG. 11A also includes lenses 12 corresponding to the optical element groups 20. Assuming that one optical element group 20 covers the width of an A4-size (201 mm×297 mm) document, the optical device of FIG. 11A can handle a document having a width three times as large as that of an A4-size document. Also, the optical device of FIG. 11A has substantially the same advantages as those of the first, third, fifth, or seventh embodiment.

FIG. 11B shows another exemplary configuration of an optical device according to the ninth embodiment formed based on the configuration of the eighth embodiment. The optical device of FIG. 11B includes a substrate 28 having a slit 29. Two sides of the substrate 28 separated by the slit 29 are joined by a joining part 24. Although not shown, it is assumed that optical element groups 20 are mounted on the two sides of the substrate 28 in a staggered manner. The optical device of FIG. 11B also includes lenses 12 corresponding to the optical element groups 20. The optical device of FIG. 11B has substantially the same advantages as those of the eighth embodiment.

### Tenth Embodiment

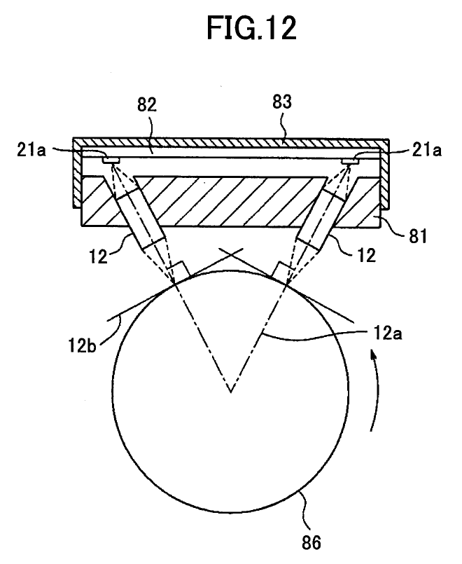

FIG. 12 is a drawing illustrating an exemplary optical device configured to form a latent image on the surface of a photosensitive drum. The exemplary optical device of FIG. 12 includes light-emitting element groups 21 composed of light-emitting elements 21a and lenses 12 corresponding to the light-emitting element groups 21. Optical axes 12a of the lenses 12 form right angles with the light-emitting surfaces of the light-emitting elements 21a. As shown in FIG. 12, the lenses 12 are held by a frame 81 and the light-emitting element groups 21 are mounted in two rows on a substrate 82. The frame 81 and the substrate 82 are held by a holding part 83. The focuses of the lenses 12 are on a surface 86 of the photosensitive drum. The lenses 12 are held by the frame 81 such that the optical axes 12a become perpendicular to tangent planes 12b of the surface 86.

The optical axes 12a of the lenses 12 are made perpendicular to the tangent planes 12b since the surface 86 of the photosensitive drum has a cylindrical shape. In other words, the optical axes 12a meets at the axis of the cylindrical photosensitive drum. Alternatively, when the optical device is configured to scan a document, the lenses 12 may be held such that the optical axes 12a become perpendicular to a flat document surface. In this case, the optical axes 12a become parallel to each other.

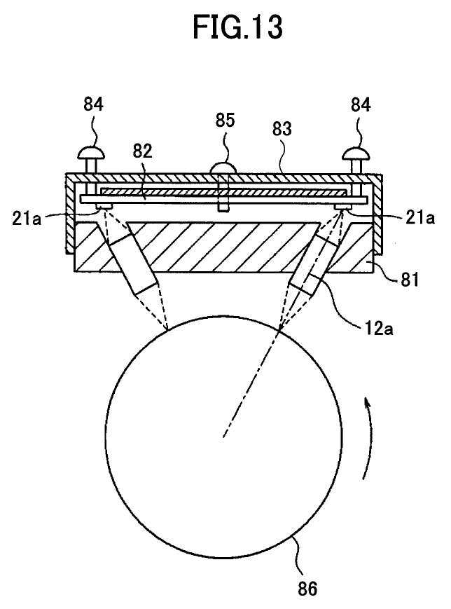

FIG. 13 is a drawing illustrating a variation of the exemplary optical device shown in FIG. 12 having a mechanism to adjust the position of the substrate 82 and thereby to adjust the positions of the light-emitting element groups 21 along the optical axes 12a of the lenses 12.

In this example, the substrate 82 is attached to the holding part 83 so as to be movable along the optical axes 12a with respect to the lenses 12. This mechanism makes it possible to move the light-emitting element groups 21 to appropriate positions within the depth of focus of the lenses 12.

As shown in FIG. 13, the center of the substrate 82 is movably attached to the holding part 83 by a fixing screw 85. Adjusting screws 84 are provided through the holding part 83 so as to touch the outer edges (areas near the light-emitting element groups 21) of the substrate 82. Rotating the adjusting screws 84 moves the substrate 82 back and forth along the optical axes 12a of the lenses 12 with respect to the fixing screw 85.

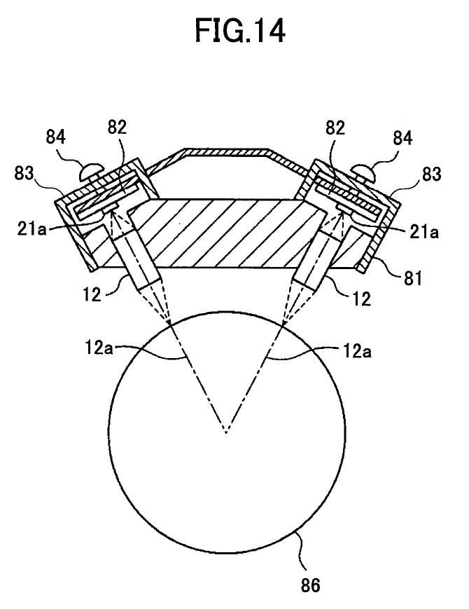

One problem with the mechanism shown in FIG. 13 is that if the substrate 82 is moved to a large extent, right angles between the light-emitting surfaces of the light-emitting elements 21a and the optical axes 12a may not be maintained. FIG. 14 is a drawing illustrating a variation of the exemplary optical device shown in FIG. 13 having a mechanism to adjust the positions of the light-emitting element groups 21 along the optical axes 12a of the lenses 12 while maintaining the right angles between the light-emitting surfaces of the light-emitting elements 21a and the optical axes 12a. In the example shown in FIG. 14, substrates 82 are attached to respective holding parts 83 so as to form right angles with the optical axes 12a of the lenses 12. An adjusting screw 84 is provided for each of the substrates 82. Rotating the adjusting screws 84 moves the substrates 82 back and forth along the optical axes 12a while maintaining the right angles between the substrates 82 and the optical axes 12a. In other words, the mechanism shown in FIG. 14 makes it possible to move the light-emitting element groups 21 to appropriate positions within the depth of focus of the lenses 12 while maintaining the right angles between the light-emitting surfaces of the light-emitting elements 21a and the optical axes 12a. Thus, compared with the mechanism shown in FIG. 13, the mechanism shown in FIG. 14 makes it possible to adjust the positions of the light-emitting elements 21a to a greater degree.

In the tenth embodiment, descriptions of parts corresponding to those described in the first through ninth embodiments are omitted.

### Eleventh Embodiment

In an eleventh embodiment, a temperature sensor is provided on a joining part of an optical device, an amount of expansion of the joining part is obtained based on a detection signal from the temperature sensor, and image signals from optical element groups are combined taking into account the obtained amount of expansion.

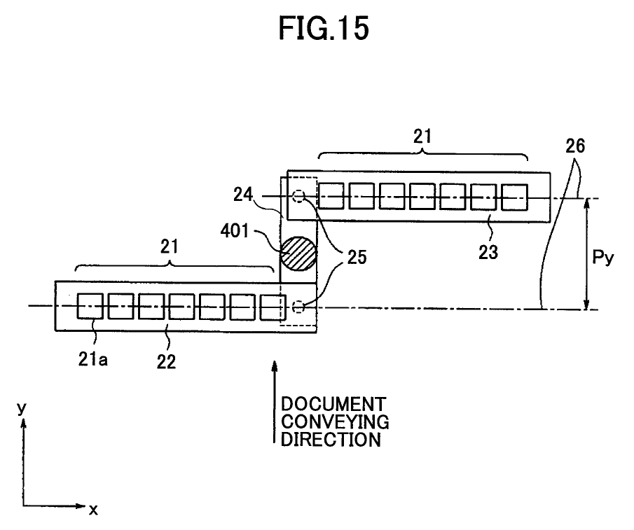

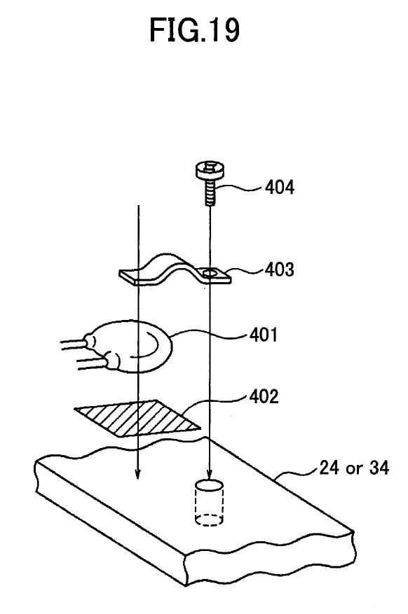

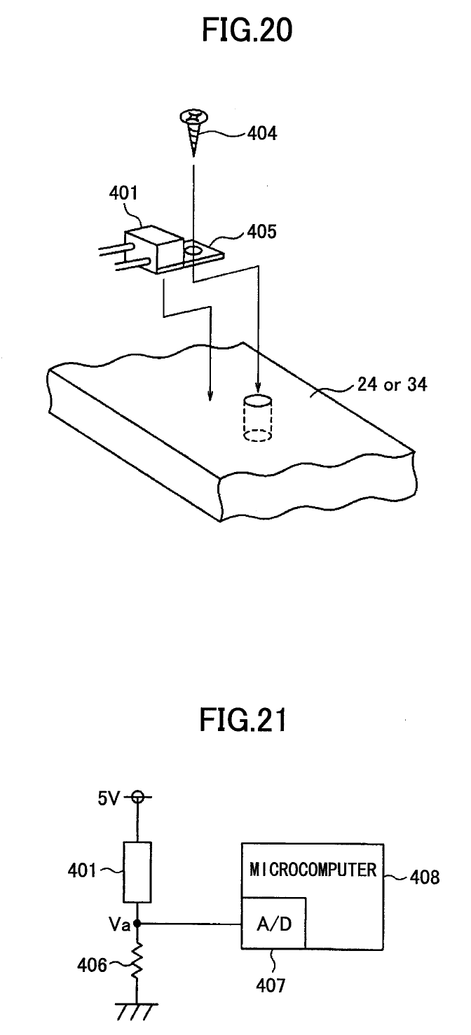

FIGS. 15 through 18 show exemplary optical devices according to the eleventh embodiment. The exemplary optical devices of the eleventh embodiment have substantially the same configurations as those of the exemplary optical devices shown in FIG. 3 through 6 except that a temperature sensor 401 is mounted on each of the joining parts 24 and 34. FIG. 19 is an exploded perspective view of an example of the temperature sensor 401 and mounting parts. In FIG. 19, the temperature sensor 401 is placed on a heat-conducting material 402, which is in contact with the surface of the joining part 24 or 34, and held down onto the heat-conducting material 402 by a pressing part 403 that is fixed to the joining part 24 or 34 by a fixing part 404 such as a screw. FIG. 20 is an exploded perspective view of another example of the temperature sensor 401 and mounting parts. In FIG. 20, the temperature sensor 401 has an attachment part 405 integrated therewith. The attachment part 405 is fixed to the joining part 24 or 34 by a fixing part 404.

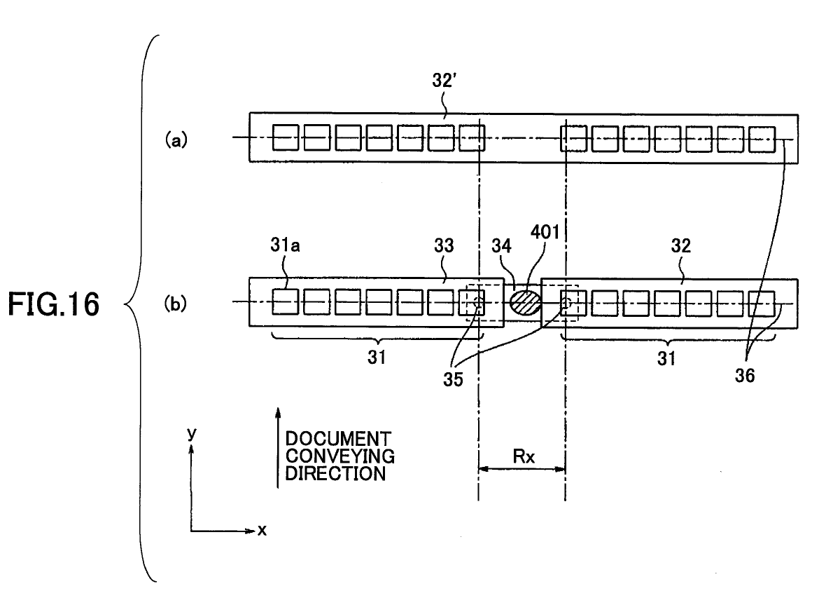

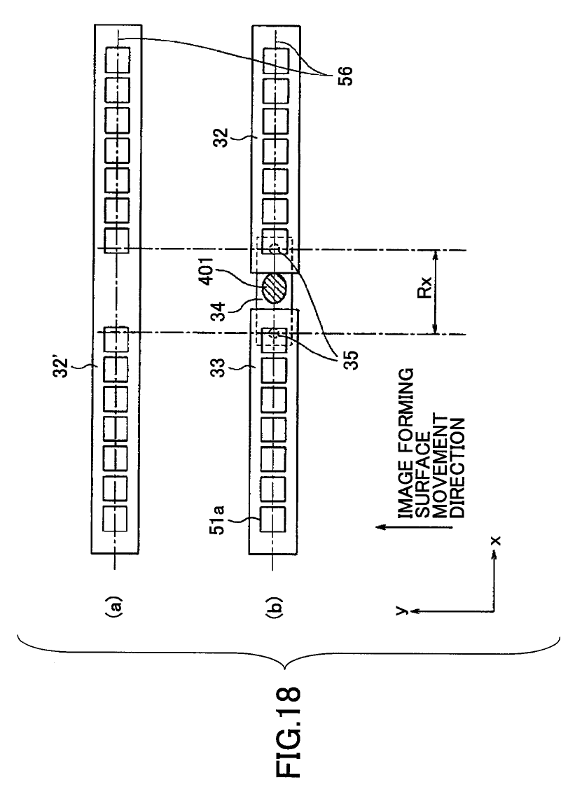

In FIGS. 16 and 18,(a) shows conventional optical devices and (b) shows the exemplary optical devices according to the eleventh embodiment.

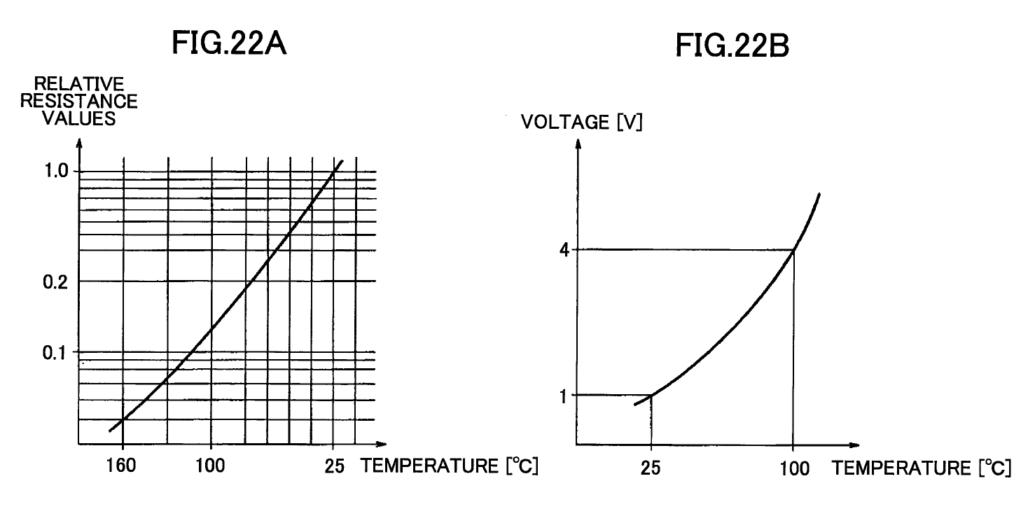

FIG. 21 is a drawing illustrating a configuration of an exemplary temperature detecting circuit according to the eleventh embodiment. The exemplary temperature detecting circuit includes the temperature sensor 401, a resistance 406, an A/D converter 407, and a microcomputer 408. A voltage (divided voltage) Va between the temperature sensor 401 and the resistance 406 is input into the A/D converter 407, converted from analog to digital, and the converted digital signal is processed by the microcomputer 408. FIG. 22A is a graph showing the relationship between temperatures detected by the temperature sensor 401 and resistance values. FIG. 22B is a graph showing the relationship between temperatures obtained by the temperature detecting circuit and voltages. In FIG. 22A, resistance values at respective temperatures are expressed as relative values to the resistance value of 1 at 25° C. As shown in FIG. 22B, the voltage Va is 1 V at 25° C. and 4 V at 100° C. Thus, a temperature detected by the temperature sensor 401 is detected as a voltage level by the microcomputer 408.

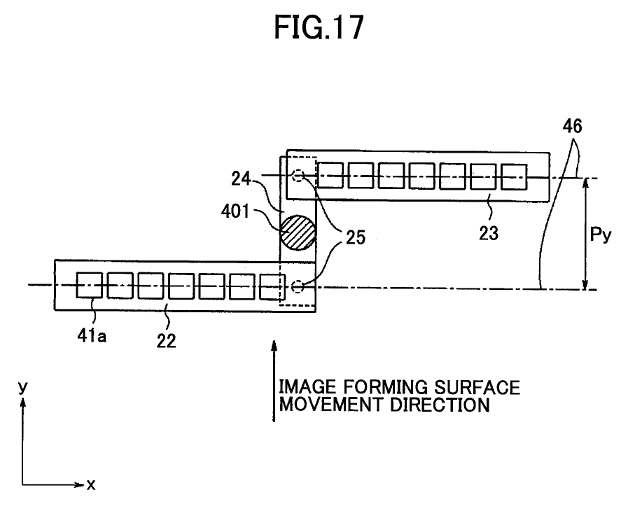

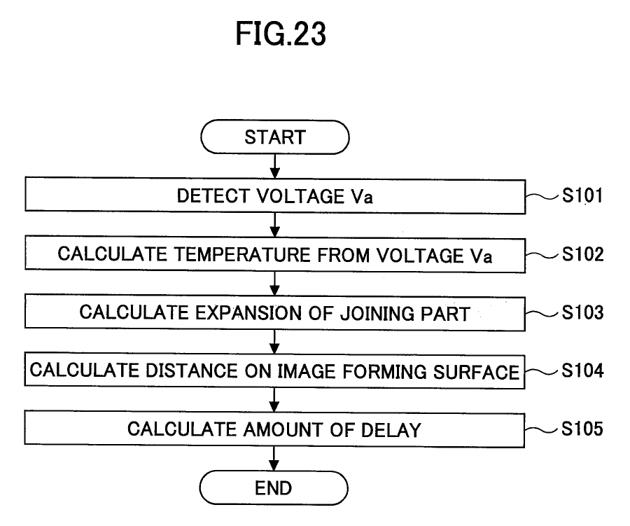

FIG. 23 is a flowchart showing an exemplary temperature detecting process performed by the microcomputer 408. As shown in FIG. 23, the microcomputer 408 detects a voltage Va (step S101) and calculates a temperature based on the voltage Va according to the relationship between temperatures and voltages as shown in FIG. 22B (step S102). The microcomputer 408 calculates the amount of expansion of the joining part 24 or 34 based on the calculated temperature and the coefficient of linear expansion of the joining part (step S103), calculates a distance on an image forming surface, on which image is to be formed, based on the calculated amount of expansion (step S104), and calculates an amount of delay for an image signal based on the calculated distance (step S105). In the exemplary optical devices shown in FIGS. 15 and 17, the substrates 22 and 23 are joined by the joining part 24 in the y direction. In this case, the distance on the image forming surface indicates the distance Py. In the exemplary optical devices shown in FIGS. 16 and 18, the substrates 32 and 33 are joined by the joining part 34 in the x direction. In this case, the distance on the image forming surface indicates the distance Rx. The amount of delay calculated in step S105 applies to the former case and indicates the amount of delay for an image signal in the sub-scanning direction.

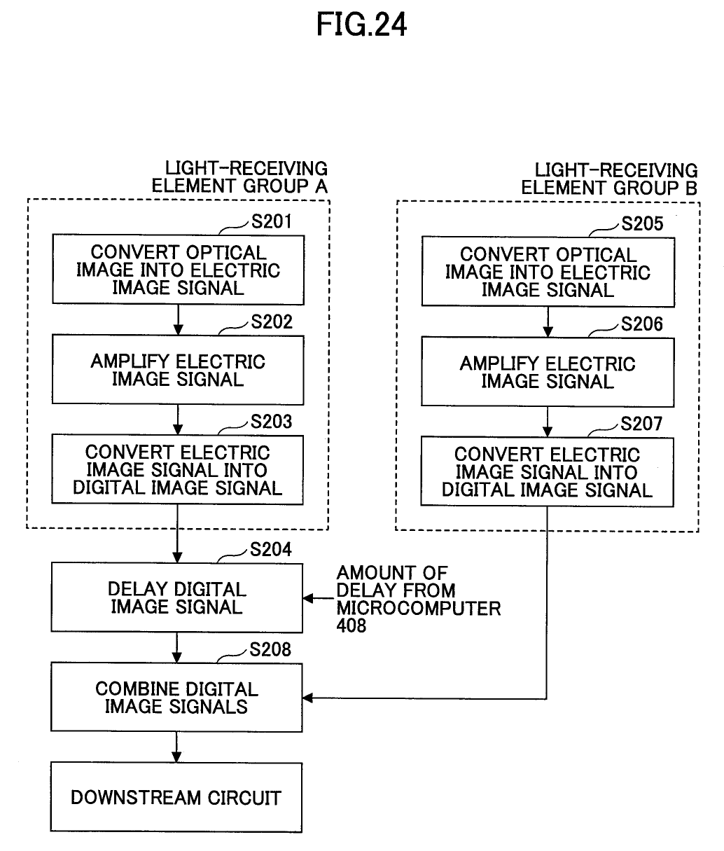

The amount of delay calculated in step S105 is used to delay an image signal in an image scanning or image forming process. FIG. 24 is a flowchart showing an exemplary process according to the eleventh embodiment of scanning an image using light-receiving element groups arranged in a staggered manner. An exemplary image scanning apparatus used in this exemplary process roughly corresponds to the mechanical unit 603A and the image processing unit 603B shown in FIG. 2 and includes a light-receiving element group A and a light-receiving element group B that are arranged in a staggered manner. The light-receiving element group A is situated upstream of the light-receiving element group B in the document conveying direction.

An optical image received by light-receiving elements of the light-receiving element group A is photoelectrically converted by a light-receiving circuit into an electric image signal A (step S201). The electric image signal A is amplified by the image amplifying circuit B1 (step S202) and converted by the A/D converting circuit B2 into a digital image signal A (step S203). On the other hand, an optical image received by light-receiving elements of the light-receiving element group B is photoelectrically converted by the light-receiving circuit into an electric image signal B (step S205). The electric image signal B is amplified by the image amplifying circuit B1 (step S206) and converted by the A/D converting circuit B2 into a digital image signal B (step S207).

The digital image signal A is delayed by a line delay circuit for the number of lines between the light-receiving element groups A and B (step S204) and combined with the digital image signal B by an image area combining circuit into an image signal corresponding to one line (step S208). Then, the combined image signal is sent to a downstream circuit. In step S204, the number of lines is determined based on the amount of delay calculated in step S105 shown in FIG. 23.

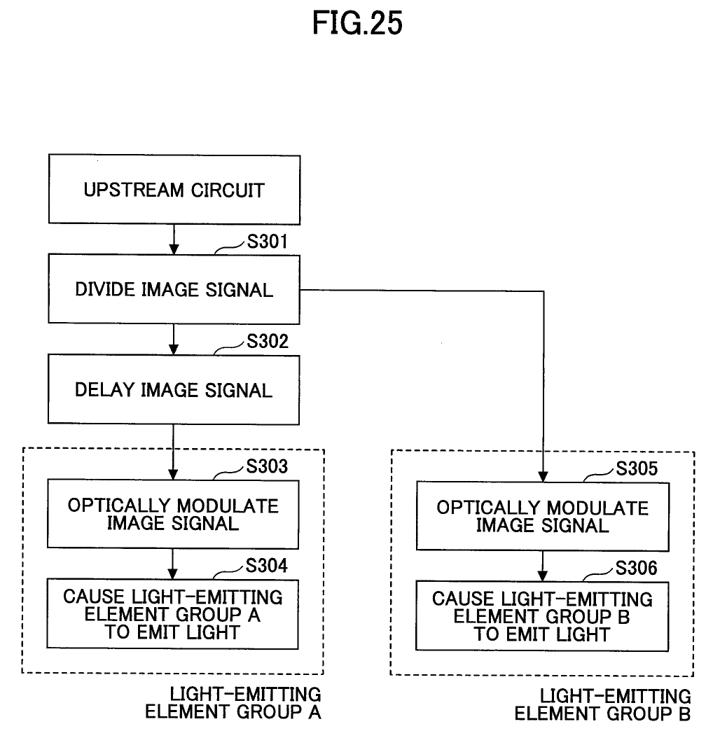

FIG. 25 is a flowchart showing an exemplary process according to the eleventh embodiment of forming an image using light-emitting element groups arranged in a staggered manner. An exemplary image forming apparatus used in this exemplary process roughly corresponds to the duplicating circuit 602A2 and the printer engine 601 shown in FIG. 2 and includes a light-emitting element group A and a light-emitting element group B that are arranged in a staggered manner. The light-emitting element group A is situated upstream of the light-emitting element group B in the movement direction of an image forming surface on which image is to be formed. In this exemplary image forming apparatus, an image signal sent from an upstream circuit is divided by an image area dividing circuit of the optical writing control circuit 602A2-1 into an image signal A for the light-emitting element group A and an image signal B for the light-emitting element group B (step S301). The image signal A is delayed by a line delay circuit (step S302) and optically modulated by an optical modulation circuit (step S303). Based on the optically modulated signal, the light-emitting element head control circuit 21c causes the light-emitting element group A to emit light and thereby writes a half of one line of an image (step S304). Also, the image signal B is optically modulated by the optical modulation circuit (step S305). Based on the optically-modulated signal, the light-emitting element head control circuit 21c causes the light-emitting element group B to emit light and thereby forms the other half of one line of the image (step S306). Thus, one line of the image is written by the light-emitting element groups A and B.

In this embodiment, as described above, the temperature sensor 401 is provided on the joining part 24 or 34 of the exemplary optical device, an amount of expansion of the joining part is obtained based on a detection signal from the temperature sensor 401, and image signals from optical element groups spaced at the distance Py or Rx are combined taking into account the obtained amount of expansion. In the exemplary image scanning apparatus described above, the line delay circuit for delaying an image signal based on the calculated amount of delay may be included in the image processing circuit B4. In the exemplary image forming apparatus described above, the line delay circuit for delaying an image signal based on the calculated mount of delay may be included in the optical writing control circuit 602A2-1. Thus, the eleventh embodiment makes it possible to accurately combine image signals from optical element groups disposed in a staggered manner and spaced by a joining part taking into account expansion of the joining part caused by temperature change.

In the eleventh embodiment, descriptions of parts corresponding to those described in the first through tenth embodiments are omitted.

In an optical device according to an embodiment of the present invention, spacing between light-receiving element groups or light-emitting element groups mounted on substrates is maintained by a joining part joining the substrates and having a thermal coefficient of expansion smaller than that of the substrates. This configuration makes it possible to reduce positional shifts of the element groups caused by expansion of the substrates due to temperature change.

In this patent application, an optical element group corresponds to the light-receiving element group 21 or 31 or the light-emitting element group 41 or 51, an expansion reducing unit corresponds to the fan 61 and the duct 62, an expansion absorbing mechanism corresponds to the gap 63 or the slit 29, an imaging optical element corresponds to the lens 12, an adjusting mechanism corresponds to the adjusting screw 84 and/or relevant components shown in FIG. 13 or 14, and a feedback unit corresponds to the microcomputer 408 and the line delay circuit.

The present invention is not limited to the specifically disclosed embodiments, and variations and modifications may be made without departing from the scope of the present invention.

The present application is based on Japanese Priority Application No. 2006-180055, filed on Jun. 29, 2006, the entire contents of which are hereby incorporated herein by reference.

What is claimed is:

1. An optical device physically movable with respect to a document surface or an image forming surface, comprising:
substrates;
optical element groups mounted on the substrates and composed of optical elements for image scanning or image forming, adjacent ones of the optical element groups being spaced at a predetermined distance in a direction that the optical device is movable; and
a joining part joining the substrates and thereby maintaining the predetermined distance, the joining part having a thermal coefficient of expansion that is smaller than that of the substrates.

2. An optical device, comprising:
substrates;
optical element groups mounted on the substrates and composed of optical elements for image scanning or image forming, the optical element groups being disposed in a line, adjacent ones of the optical element groups being spaced at a predetermined distance; and
a joining part joining the substrates and thereby maintaining the predetermined distance, the joining part having a thermal coefficient of expansion that is equal or close to that of the substrates.

3. The optical device as claimed in claim 1, wherein a distance between joint positions where the joining part is attached to the substrates is larger than the predetermined distance.

4. The optical device as claimed in claim 1, wherein a ratio of the predetermined distance to a distance between joint positions, where the joining part is attached to the substrates, is equal to a ratio of a difference between the thermal coefficient of expansion of the substrates and the thermal coefficient of expansion of the joining part to the thermal coefficient of expansion of the substrates.

5. The optical device as claimed in claim 1, further comprising:
an expansion reducing unit placed on the joining part and configured to reduce an amount of expansion of the joining part which expansion is caused by temperature change.

6. The optical device as claimed in claim 1, wherein a gap is provided between the substrates to absorb expansion of the substrates which expansion is caused by temperature change.

7. An optical device physically movable with respect to a document surface or an image forming surface, comprising:
a substrate having a slit;
optical element groups composed of optical elements for image scanning or image forming and mounted on two sides of the substrate separated by the slit, adjacent ones of the optical element groups being spaced at a predetermined distance in a direction that the optical device is movable; and
a joining part joining the two sides of the substrate and thereby maintaining the predetermined distance, the joining part having a thermal coefficient of expansion that is smaller than that of the substrate.

8. The optical device as claimed in claim 1, further comprising:
imaging optical elements corresponding to the optical elements of the optical element groups, wherein the imaging optical elements are disposed such that the optical elements are positioned within depth of focus of the imaging optical elements.

9. The optical device as claimed in claim 8, wherein the imaging optical elements are held such that optical axes of the imaging optical elements form essentially right angles with the document surface or with corresponding tangent planes of the image forming surface.

10. The optical device as claimed in claim 9, further comprising:
an adjusting mechanism configured to move the optical elements to desired positions within the depth of focus of the imaging optical elements.

11. The optical device as claimed in claim 10, wherein the substrates are held so as to form right angles with the optical axes of the imaging optical elements.

12. The optical device as claimed in claim 1, further comprising:
a temperature sensor disposed on the joining part and configured to detect a temperature of the joining part; and
a feedback unit configured to obtain an amount of expansion of the joining part based on the detected temperature, to calculate an amount of delay for an image signal from corresponding one of the optical element groups based on the obtained amount of expansion, and to delay the image signal based on the calculated amount of delay.

13. The optical device as claimed in claim 1, wherein the joining part is a steel plate.

14. The optical device as claimed in claim 1, wherein the optical elements are light-receiving elements for image scanning.

15. The optical device as claimed in claim 1, wherein the optical elements are light-emitting elements for image forming.

16. An image scanning apparatus including the optical device as claimed in claim 14.

17. An image forming apparatus including the optical device as claimed in claim 15.
